(19) United States
(12) Patent Application Publication
(10) Pub. No.: US 2025/0181395 A1
(43) Pub. Date: Jun. 5, 2025

(54) AUTOMATIC RESOURCE ALLOCATIONS TO DIFFERENT SOURCES BASED ON EVENT SEQUENCES DERIVED FROM THE SOURCES

(71) Applicants: DISH Network L.L.C., Englewood, CO (US); DISH Network Technologies India Pvt. Ltd, Bangalore (IN)

(72) Inventors: Vinay Wasudeo Tiwari, Englewood, CO (US); Yong-Joon Oh, Morgan Hill, CA (US); Vignesh Narayanaswamy, Tamil Nadu (IN); Amith Kumar Ullur Raghavendra, Bangalore (IN); Giri Prasad Sekar, Bengaluru (IN); Shubham Kumar Singh, Uttar Pradesh (IN); Kalleri Faizel Rehiman, Fremont, CA (US)

(21) Appl. No.: 18/525,310

(22) Filed: Nov. 30, 2023

(51) Int. Cl. G06F 9/50; H04L 41/16

(52) U.S. Cl. CPC G06F 9/5027; G06F 9/5072; H04L 41/16

(57) ABSTRACT

A method of automatically allocating resources to digital channels includes receiving, at a cloud server running on a multi-node cloud system, one or more events associated with each of a plurality of users from at least one of a plurality of digital channels; constructing, by the cloud server, a sequence of events for each of the plurality of users; generating, using a machine learning model, a value for each of the plurality of digital channels for each of the plurality of users based on the respective sequences of events of the plurality of users. The method further includes calculating a second value for each of the plurality of digital channels based on the first value of each of the plurality of users and an attribute of each of the plurality of users; and automatically allocating resources to each of the plurality of digital channels based on the respective second value.

### TECHNICAL FIELD

The present disclosure relates generally to cloud servers, more particularly, to systems and methods for automatically allocating resources to digital channels based on sequences of events derived from the digital channels.

### BRIEF SUMMARY

Subscription-based services, such as live TV streaming services, face an ongoing challenge in acquiring high-worth customers (also referred to users in this disclosure). A factor in this endeavor is the effective allocation of resources across multiple channels. While each channel has the potential to drive user acquisition, it is difficult to discern the precise impact and influence of each channel in the user conversion process.

Traditionally, decision-makers have relied on experiential knowledge and broad assumptions to allocate resources across channels. This approach often fails to capture the real-time dynamics of the market. For example, decision-makers may allocate more resources to channels that have historically been effective, even if their impact has diminished over time. Additionally, traditional methods may fail to account for the sequence of events experienced by each individual user on the channels.

Described herein are systems and methods for automatically allocating resources to different digital channels based on each channel's contribution to each user's conversion derived from a sequence of events leading to the user's conversion.

In one embodiment, the techniques described herein relate to a method of automatically allocating resources to digital channels, including: receiving, at a cloud server, one or more events associated with each of a plurality of users from at least one of a plurality of digital channels; constructing, by the cloud server, a sequence of events for each of the plurality of users; generating, using a machine learning model, a value for each of the plurality of digital channels for each of the plurality of users based on the respective sequences of events of the plurality of users; calculating, by the cloud server, a second value for each of the plurality of digital channels based on the first value of each of the plurality of users and an attribute of each of the plurality of users; automatically allocating resources to each of the plurality of digital channels based on the respective second value.

According to other embodiments, the method can be implemented by a system and/or a computer readable storage medium as described herein.

This approach to allocating resources to different digital channels leverages each user's journey from a variety of sources to identify the precise impact and influence of each channel in the user conversion process. Therefore, this approach can achieve high levels of accuracy in attributing user conversions to the correct channels, which allows marketing budgets to be more strategically allocated. Further, the system is periodically trained using users' events data, ensuring that the system can capture the market dynamics.

Further, in an embodiment, the functions of the cloud server can be distributed across multiple processing nodes to increase the system's scalability, fault tolerance, and performance in terms of processing speed of the system. For instance, a separate processing node can be configured with APIs compatible with a particular digital channel, allowing it to receive event data from that digital node. Once the event data for all users are received, multiple processing nodes can be used to construct sequences of events for different subsets of the plurality of users.

In a different embodiment, all the event data received from the various digital channels can be loaded into a distributed shared memory (DSM). The DSM can be accessed by multiple processing nodes when they need event data for processing. The introduction of DSM enhances the system's scalability since it allows more processing nodes to be added as more processing power is needed. As the system expands, it offers increased memory resources to the applications, boosting overall performance. Further, the DSM facilitates the efficient use of memory resources spread across different machines. If a node is grappling with high memory consumption, it has the capability to tap into the unused memory of other nodes, enhancing the adaptability of the cloud-based computing system.

As shown above and in more detail throughout the disclosure, various embodiments of the disclosure provide technical improvements over existing systems for resource allocations to digital channels. These and other features and advantages of the disclosure will become more readily apparent in view of the embodiments described herein and illustrated in this specification.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 is a block diagram illustrating an example of a system for automatically allocating resources to digital channels according to an embodiment of the disclosure.

FIG. 2 is a block diagram illustrating input features and the output values of the deep learning model and the channel weight allocation algorithm according to an embodiment of the disclosure.

FIGS. 3A and 3B illustrate example input features and example output values according to an embodiment of the disclosure.

FIG. 4 is a block diagram further illustrating the user classifier according to an embodiment of the disclosure.

FIG. 5 is a block diagram further illustrating the resource allocation module according to an embodiment of the disclosure.

FIG. 6 is a block diagram illustrating a process of automatically allocating resources to digital channels according to an embodiment of the disclosure.

FIG. 7 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments can be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments can be methods, systems, media, or devices. Accordingly, the various embodiments can be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

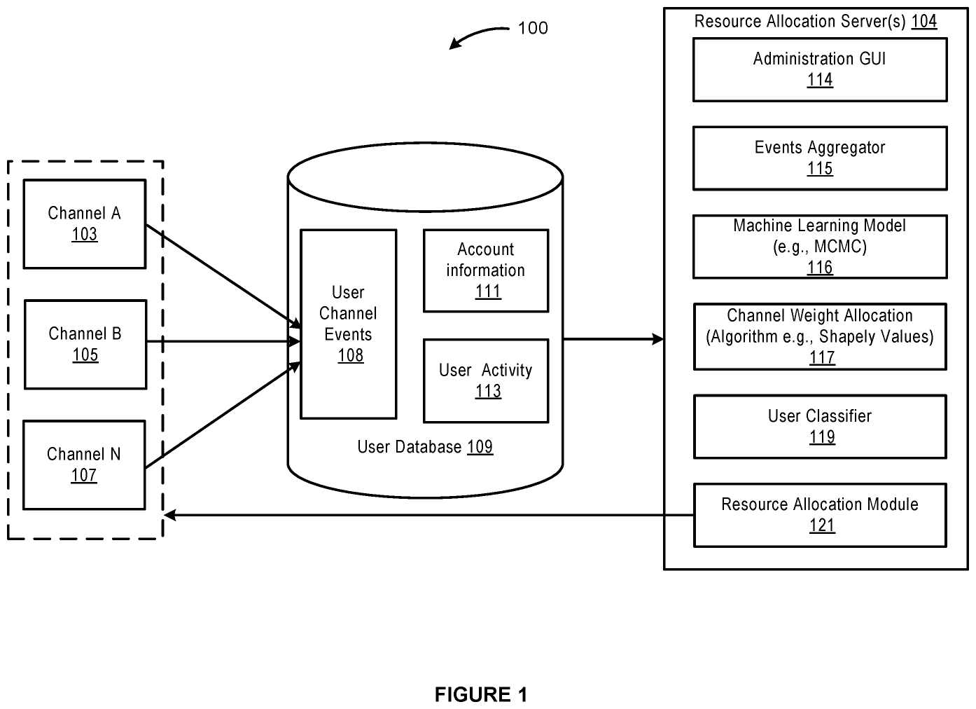

FIG. 1 is a block diagram illustrating an example of a system 100 for automatically allocating resources to digital channels according to an embodiment of the disclosure. The system 100 can act as a marketing automation system or part of such a system. The system 100 can reside in the cloud and can include a resource allocation server 104 and a user database 109. The resource allocation server 104 can represent one or more cloud servers of any type, such as public cloud servers, private cloud servers, and virtual private servers. The user database 109 is a cloud database, which can be a database service built and accessed through a cloud-based platform, and is designed to deliver scalable, reliable, and cost-effective database functionality, without the physical burdens of setting up, maintaining, and administering on-premises databases.

In an embodiment, the resource allocation server 104 can include a software stack that enables access to a cloud database (e.g., database 109) and integration with digital channels 103-107 (also referred to as “channels”), such as Facebook and Google's search engine. Such a software stack can comprise several layers of software components, from the operating system to specialized application interfaces. Examples of the software components in the software stack can include an operating system, and a database management system (DBMS) used to interact with the cloud database 109. Examples of the DBMS can include PostgreSQL, MySQL, or MongoDB for facilitating structured storage, retrieval, and management of data. The software stack can further include a web server, such as Apache, Nginx, or IIS, that serves content to users. Further, the software stack can include one or more backend frameworks, such as Django, Flask, Ruby on Rails, or Node.js, that process requests, interfacing with the database 109, and handling business logic. The software stack can further include an application programming interface (API) middleware that enables interaction with the digital channels 103-107.

In one embodiment, the channels 103-107 represent pathways within the digital ecosystem for distributing multimedia content and/or facilitating user engagement. Each channel can offer entities avenues to promote their products or services, guiding potential users through a series of events that lead to a purchase of a product or a conversion to a user.

The channel 103 can be a social media advertising channel, such as Facebook or Instagram, where advertisers can tailor content to target demographics, ensuring ads reach the appropriate audience. A typical user journey in this type of channel might begin with viewing a sponsored post, then engaging with it through likes or comments, and finally clicking on the ad's call-to-action. This action could direct them to a product page or prompt them to explore other channels for more information.

The channel 105 can represent a search engine advertising channel, such as Google Ads. When users enter search queries, sponsored links or ads might appear at the top or alongside organic search results. In this type of channel, a user's journey typically starts with the initial search, followed by seeing the ad, clicking on it due to its relevance, and then landing on the advertiser's website or product page.

The channel 107 can represent an e-commerce advertising platform, such as Amazon's sponsored products. On this platform, items are displayed when users search for related products. The user's journey typically begins with browsing, encountering a sponsored product, clicking on it for more details, and potentially adding it to the cart for purchase.

The channels 103-107 can also include a variety of other digital channels, such as a video advertisement platform or a messaging-based advertisement channel. YouTube serves as an example of the former, where advertisers can place video ads before, during, or after content relevant to their products. A viewer's journey might begin with watching a chosen video, encountering an advertisement, becoming interested, clicking the ad's link, and subsequently being redirected to a product or service page. On the other hand, WhatsApp exemplifies the latter type of channel. Within this platform, users might receive promotional messages or discover business profiles. Their journey involves receiving a promotional message, engaging with interactive elements (like quick replies or carousels), and following links to explore or purchase products.

In the context of a subscription-based service, such as Sling TV, users' journeys can be categorized into two paths: user journeys and non-user journeys. Each of these pathways represents a sequence of interactions or events that a user experiences while engaging with the channels distributing information related to the service.

A potential user's journey can start with the initial discovery of the service. This can arise from various sources such as online advertising, word-of-mouth, or a friend's recommendation. Following this initial awareness, potential users can do their own research. They can visit the service's website, check available channels and packages of the service, and read reviews and promotional videos. Many subscription platforms offer free trials, and potential users can use the trial period to weigh the service's merits. This journey ends up in a decision: to subscribe or to seek alternatives.

In one embodiment, the sequence of events in either type of journey can spread across multiple digital channels since a user may often visit more than one digital channel before their final decision. Examples of the events can include impression, click, session duration, form submission, video play, video completion, conversion, and download. An impression is recorded when an advertisement or content is fetched and displayed in a user's device, regardless of whether it was clicked. A click is registered when a user clicks on an advertisement or link. A session duration can be recorded as the amount of time a user spends during one visit. A form submission is recorded when a user submits a form. A video play is recorded when a user starts watching a video. A completion is recorded when a user watches a video until the end. A download is recorded when a user downloads a file, software, or application.

It should be appreciated that the above list of digital events is not exhaustive and it is merely provided for examples and may not be provided in the order they actually may occur.

When a digital event occurs on a channel, a variety of information can be recorded depending on the nature of the event, the capabilities of the tracking tools in place, and the permissions granted by the user, and agreements between the channel and an advertiser. However, in this disclosure, the digital channels can record at least event details, user information, channel and content details, and engagement metrics.

The event details can include the type of the event (e.g., click, impression, conversion, video view, etc.); a timestamp indicating the exact date and time when the event occurred; and an event duration indicating, e.g., the length of time a video was viewed or how long a user engaged with a piece of content.

The user information can include a user ID representing an identifier of a user; a location indicating a geographical data of the user; and a device information indicating the user's device such as type (mobile, desktop, tablet), brand, and model.

The channel and channel contents can include a referrer representing a source that led the user to the content, such as a search engine, social network, or another website. The channel and channel contents can also include a URL representing the web address where the event took place.

The engagement metrics can include scroll depth, which indicates how far a user scrolled on a page; interactions, which can signify any action taken, such as button clicks or form submissions; and interactions with multimedia elements.

The recorded events can be sent and stored to a user channel events table 108 in the user database 109. As shown, the database also includes account information 111 and user activity 113. Unlike the user channel events table 108 that stores digital events for anyone (user or non-user) that had any type of interactions with advertisements posted on any of the channels 103-107, the account information database 111 and the user activity database 113 only store information of users of the promoted services by the system 100.

In one embodiment, the database 109 includes account data 111 pertaining to users of a subscription-based live TV streaming service. This account data may include the user's name, contact details, and specific subscription particulars such as types of plans. Additionally, it includes billing data and a record of payment history. The user activity 113 may include the watching behaviors of each user. This entails metrics like the daily hours spent watching, specific times of the day when the user is most active, preferred channel types, and so on.

As further shown in the figure, the resource distribution server 104 may include multiple applications for automatically allocating resources to the channels 103-107. These applications include an administration GUI (graphical user interface) 114, an events aggregator 115, a machine learning model 116, a channel weight allocation algorithm 117, a user classifier 119, and a resource allocation module 121.

The events aggregator 115 can aggregate events from users that the system 100 has obtained and stored in the user channel events table 108, organizing them into time-series sequences. This includes events from both users and non-users, provided they have interacted with ads disseminated by system 100. Each time-series sequence chronicles the path leading to a user's decision to subscribe or not.

In one embodiment, the time-series sequences of events aggregated by the events aggregator 115 can chronicle a user's interactions across multiple channels. As an illustrative example, consider the journey of Jane, a prospective user. She initially comes across an ad for the service on a social media platform like Facebook. Interested, she searches for more details about the service on Google. Her search leads her to a YouTube review video that provides an in-depth look at the service's offerings. Each of these touchpoints—the social media interaction, the Google search, and the YouTube video viewing—can be recorded with their exact timestamps by the respective channels where the touch points occurs. These interactions, when aggregated and sequenced based on their respective timestamps, provide an objective and comprehensive representation of Jane's digital engagement pathway, leading up to her action to subscribe.

The machine learning model 116 is trained and retrained using journey data from both users and non-users. It works in conjunction with the channel weight allocation algorithm 117 to determine each channel's contribution to a user's conversion. An example of the machine learning model 116 is the Markov Chain Monte Carlo (MCMC) model, while an example of the channel weight allocation algorithm 117 is the Shapley Values algorithm.

The user classifier 119 can be a convolutional neural network (CNN) used to segment users into different groups based on criteria derived from both account information and user activity. This classification can assist the resource allocation module 121 to allocate resources to different digital channels. It should be noted that resources in this disclosure are not limited to financial resources; they can be other types of resources as well, such as manpower and talent.

The resource allocation module 121 can allocate resources to different channels based on channel weights related to the conversion of users and the values of the converted users.

The administration GUI 114 can serve as a central command and visualization hub for system administrators. It can display metrics, such as the weights assigned to each digital channel, providing decision-makers with a holistic overview of channel contributions and the proposed resource allocation. This ensures that they can make informed decisions and adjustments.

In one embodiment, the cloud-based system 100 can comprise a plurality of processing nodes. Each processing node is tasked with performing a portion of the operations for automatically allocating resources to digital channels. The functions of the cloud server can be distributed across multiple processing nodes to increase the system's scalability, fault tolerance, and performance in terms of processing speed of the system. Additionally, the cloud-based system 100 is equipped with a distributed shared memory (DSM) architecture, which enhances the system's scalability and flexibility because the DSM allows more processing nodes to be added as more processing power is needed and/or also allows a node with high memory consumption to tap into the unused memory of other nodes.

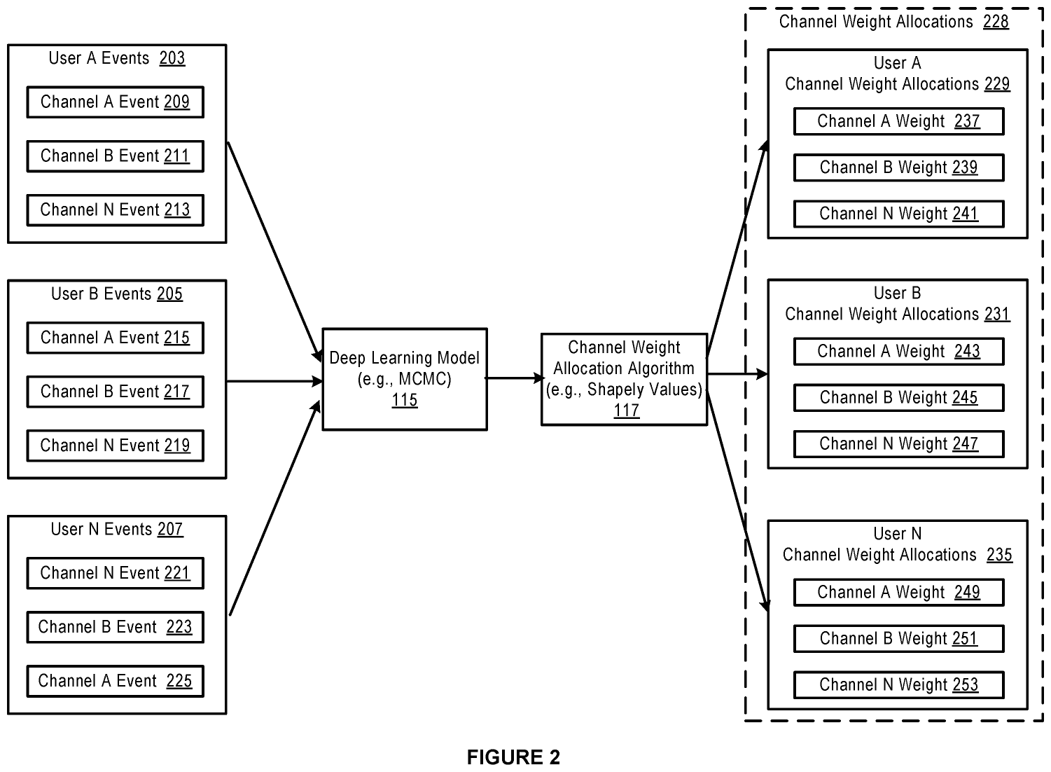

FIG. 2 is a block diagram illustrating input features and the output values of the machine learning model 116 and the channel weight allocation algorithm 117 according to an embodiment of the disclosure.

As shown, the input features can be a sequence of events across multiple digital channels experienced by a user. User A events 203 are a sequence of events 209-213 experienced by user A. User B events 205 are a sequence of events 215-219. Similarly, user N events 207 are a sequence of events experienced by customer N. Each of the events 209-225 can be a different event. Alternatively, at least some of the events 209-225 can be the same events but occur on different digital channels. Although only one event is shown from each channel, multiple events from a single channel can be used as input features to the machine learning model 116.

The output values, as shown by channel weight allocations 228, represent three sets of channel weight allocations 229-235 across three different digital channels (i.e., channel A, channel B, and channel N in this figure) for three different users (i.e., user A, user B, and user N). In each set of channel weight allocations 229-235, a weight given to a channel can be represented by a decimal number or a percentage number.

As an illustration, the set of channel weight allocations 229 for user A can be 30% for channel A, 30% percent for channel B, and 40% for channel N, while the set of channel weight allocations 231 for user B can be 50% for channel A, 40% for channel B, and 10% for channel N. In user A's scenario, channel A contributes to 30% of the conversion. In contrast, for user B, the same channel A contributes to 50% of the conversion.

In one embodiment, the machine learning model 116 can be trained initially using a large dataset obtained from different channels, and then periodically retrained using data obtained from the channel during each period. For example, if the machine learning model 116 is retrained weekly, then the data for retraining can be data obtained from the channels each week.

As described above, the machine learning model 116 can be an MCMC model and the channel weight allocation algorithm 117 can be a Shapely values algorithm. The MCMC model 116 is a machine learning model in the sense that it is a computational algorithm that can learn from data, although it is not a supervised learning model and therefore does not require labeled data to train. However, the MCMC model still needs to be trained and retrained to sample from the posterior distribution of the model parameters. The posterior distribution is the distribution of the model parameters given the data. Once the MCMC is trained, the samples from the posterior distribution can be used to make inferences about the underlying process that generated the data.

In one implementation of generating the channel weight allocations 228 for the users A-N using the machine learning model 116 and the channel weight allocation algorithm 117 together, the resource allocation server 104 can construct multiple probabilistic models, with each probabilistic model representing the journey of one of the users.

As described above, each of the sets of events 203-207 can be a comprehensive collection of all data available detailing a user's interactions across various digital channels. The interactions include not only which channels that the user engaged with but also the sequence of those interactions. Further, the interactions may include event-level details since each channel might have multiple events (like viewing an ad, clicking on a product link, watching a promotional video, etc.). Since each journey represents a sequence of events. Given the multiple channels and the numerous events within each individual channel, numerous probabilistic models may need to be constructed.

As a next step of the implementation, the MCMC model 116 can be used to draw samples from the distribution of models previously constructed. The samples drawn are then used to estimate features of the distribution of contributions of different channels, such as means or variances.

Next, the Shapely values algorithm 117 can be used to distribute the value of conversion to different channels. The Shapely values algorithm 117 conceptualizes each channel (and its events) as a player in a cooperative game where the combined “winnings” is equivalent to the successful conversion of a user. In accordance with the algorithm 117, the value of the conversion can be distributed amongst the players based on their marginal contributions and the features of the distribution estimated from the drawn samples. The marginal contribution of a channel would be the difference in conversion probability with and without that channel's involvement.

In one embodiment, the machine learning model 116 can be retrained using data aggregated from the different channels for users and non-users. However, the execution of the model 116 may be manually triggered, or automatically triggered when the number of newly converted users reached a threshold.

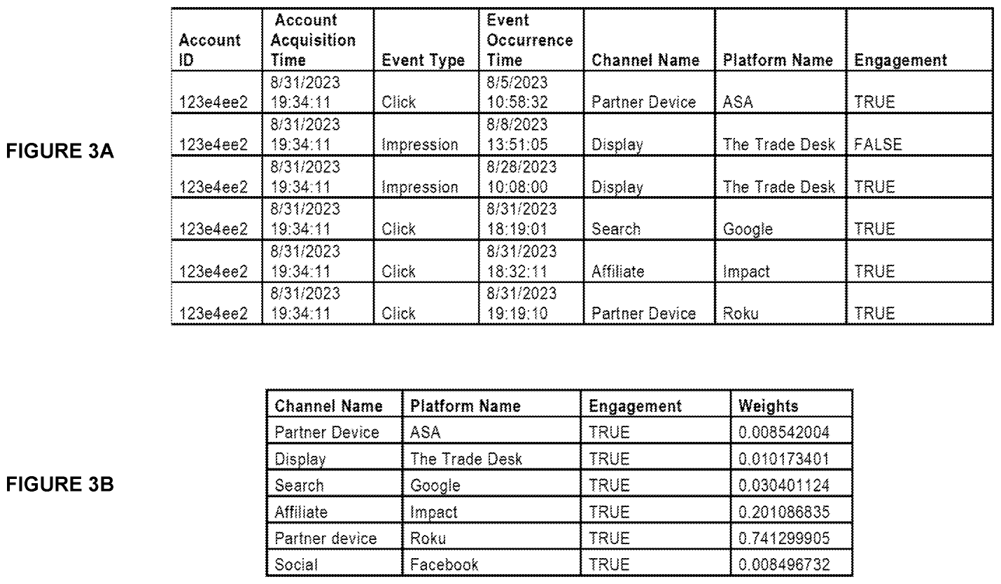

FIGS. 3A and 3B illustrate example input features to the machine learning model 116 and example output values of the machine learning model 116 according to an embodiment of the disclosure. These features and output values are for a single user and are provided as illustration.

In FIG. 3A, 6 channels with 6 events are shown, together with their timestamps, and the channels where they occur. The 6 events are arranged chronologically, with the first event occurring at Aug. 5, 2023, 19:34:11 on the channel of “Partner Device” and the last event occurring at Aug. 31, 2023 19:19:10 on the same channel. The other 4 events occurred on different days on different channels. The user is acquired at Aug. 31, 2023 19:34:11, as shown by the column of “Account Acquisition Time”. Thus, the journey of the user chronicles a sequence of events that leads to the conversion of the user.

In FIG. 3B, the weights of the channels are generated by the machine learning model 116 based on the input features shown in FIG. 3A, with the channel “Partner device” allocated the largest weight (0.74 or 74%). This means that that channel is primarily responsible for the user's conversion according to the machine learning model 116 and the Shapely values algorithm 117.

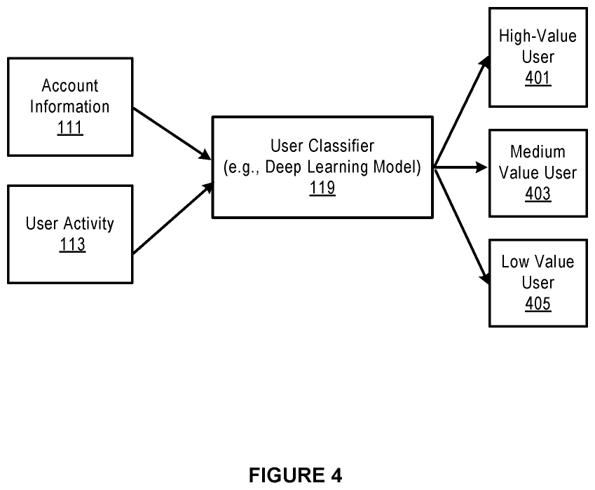

FIG. 4 is a block diagram further illustrating the user classifier 119 according to an embodiment of the disclosure. The user classifier 119 can be implemented as a convolutional neural network model trained to classify users into different groups. The user classifier 119 can classify users into one of the three groups 401-405 based on their account information 111 and their activity 113.

In one embodiment, the resource allocation server 104 can assign a value to each group and each users in the same group can have the same value. The value of the user can be a dollar amount indicating how much value the user represents to the advertiser.

Alternatively, the user classifier 119 can be trained to generate a value for each user.

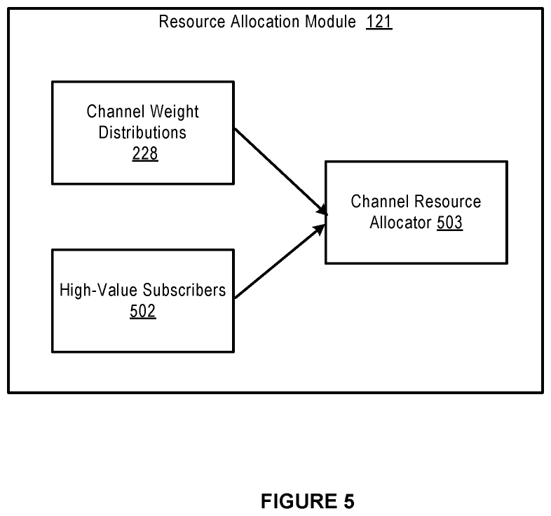

FIG. 5 is a block diagram further illustrating the resource allocation module 121 according to an embodiment of the disclosure. The resource allocation module 121 may include a channel resource allocator 503 that is configured to calculate the worth of each channel based on the channel's collective contribution to the conversion of the group of high-value users 502. Utilizing each channel's collective contribution, the channel resource allocator 503 can automatically allocate resources to that channel.

As an example, the threshold set by the system administrator via the administration GUI 114 might be 20,000 newly acquired users. If only 19,000 users have been acquired since the last time the machine learning model 116 ran, the machine learning model 116 would not run, even if it has been retrained multiple times based on event data related to both users and non-users obtained from the channels during the period.

Once the 20,000 mark is reached, the machine learning model 116 will run to determine channel contributions to each of the 20,000 newly acquired users. The user classifier 119 will then classify the 20,000 users into different groups. If, for instance, 10,000 users out of the 20,000 are classified into the high-value user group 401, the channel resource allocator 503 will calculate each channel's collective contribution to the conversion of the 10,000 high-value users. Based on each channel's collective contribution and the group's overall value, the value for each channel can be determined.

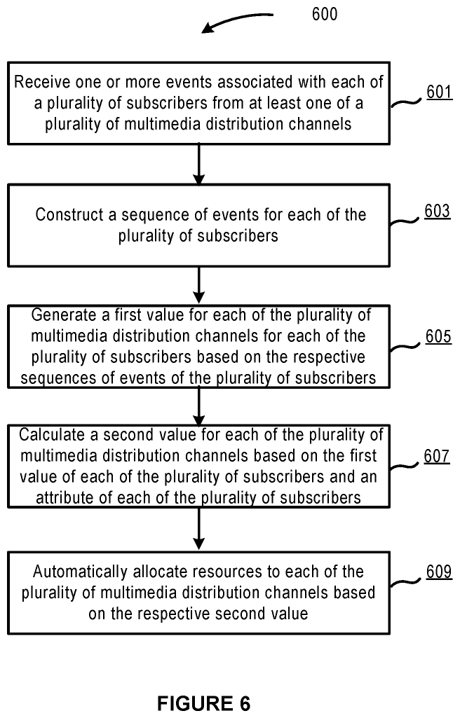

FIG. 6 is a block diagram illustrating a process 600 of automatically allocating resources to digital channels according to an embodiment of the disclosure. The process 600 can be performed by a processing logic that includes software, hardware, or a combination thereof. For example, the process 600 can be performed by the various applications on the cloud server 104 described in FIG. 1.

At step 601, the processing logic receives one or more events associated with each of a plurality of users from at least one of a plurality of digital channels.

At step 603, the processing logic constructs a sequence of events for each of the plurality of users.

At step 605, the processing logic generates, using a machine learning model, a value for each of the plurality of digital channels for each of the plurality of users based on the respective sequences of events of the plurality of users.

At step 607, the processing logic calculates a second value for each of the plurality of digital channels based on the first value of each of the plurality of users and an attribute of each of the plurality of users.

At step 609, the processing logic automatically allocates resources to each of the plurality of digital channels based on the respective second value.

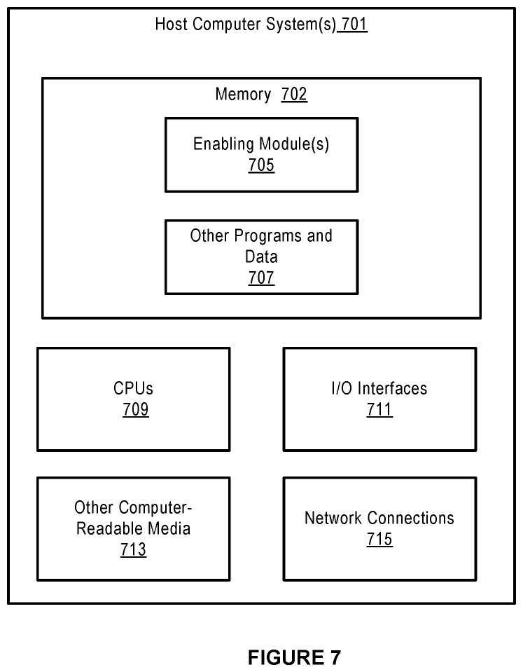

FIG. 7 shows a system diagram that describes an example implementation of a computing system(s) for implementing embodiments described herein.

The functionality described herein for automatically allocating resources to digital channels based on sequences of events derived from the digital channels can be implemented either on dedicated hardware, as a software instance running on dedicated hardware, or as a virtualized function instantiated on an appropriate platform, e.g., a cloud infrastructure. In some embodiments, such functionality can be completely software-based and is designed as cloud-native, meaning that they are agnostic to the underlying cloud infrastructure, allowing higher deployment agility and flexibility. However, FIG. 7 illustrates an example of underlying hardware on which such software and functionality can be hosted and/or implemented.

In this embodiment, an example host computer system(s) 701 is used to represent one or more of those in various data centers, base stations and cell sites shown and/or described herein that are, or that host or implement the functions of: routers, components, microservices, nodes, node groups, control planes, clusters, virtual machines, network functions (NFs), intelligence layers, orchestrators and/or other aspects described herein, as applicable, for dynamically allocating users to different plans for cost minimization in a wireless network. In some embodiments, one or more special-purpose computing systems can be used to implement the functionality described herein. Accordingly, various embodiments described herein can be implemented in software, hardware, firmware, or in some combination thereof. Host computer system(s) 701 can include memory 702, one or more central processing units (CPUs) 709, I/O interfaces 711, other computer-readable media 713, and network connections 715.

Memory 702 can include one or more various types of non-volatile (non-transitory) and/or volatile (transitory) storage technologies. Examples of memory 702 can include, but are not limited to, flash memory, hard disk drives, optical drives, solid-state drives, various types of random-access memory (RAM), various types of read-only memory (ROM), neural networks, other computer-readable storage media (also referred to as processor-readable storage media), or the like, or any combination thereof. Memory 702 can be utilized to store information, including computer-readable instructions that are utilized by CPU 709 to perform actions, including those of embodiments described herein.

Memory 702 can have stored thereon enabling module(s) 705 that can be configured to implement and/or perform some or all of the functions of the systems, components and modules described. Memory 702 can also store other programs and data 707, which can include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, intelligence layer software, network functions (NF), artificial intelligence (AI) or machine learning (ML) programs or models to perform the functionality described herein, user interfaces, operating systems, other network management functions, other NFs, etc.

Network connections 715 are configured to communicate with other computing devices to facilitate the functionality described herein. In various embodiments, the network connections 715 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 711 can include video interfaces, other data input or output interfaces, or the like. Other computer-readable media 713 can include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A method of automatically allocating resources to digital channels, comprising:
receiving, at a cloud server, one or more events associated with each of a plurality of users from at least one of a plurality of digital channels;
constructing, by the cloud server, a sequence of events for each of the plurality of users using a plurality of processing nodes, wherein each of the plurality processing nodes is configured to construct sequences of events for a subset of the plurality of users;
generating, using a machine learning model, a first value for each of the plurality of digital channels for each of the plurality of users based on the respective sequences of events of the plurality of users;
calculating, by the cloud server, a second value for each of the plurality of digital channels based on the first value of each of the plurality of users and an attribute of each of the plurality of users; and
automatically allocating resources to each of the plurality of digital channels based on the respective second value.

2. The method of claim 1, wherein each of the one or more events is one of: impression, click, engagement, and conversion.

3. The method of claim 1, wherein the machine learning is a Markov chain Monte Carlo (MCMC) model.

4. The method of claim 2, wherein the machine learning model is used in conjunction with a Shapley values algorithm to generate the first value.

5. The method of claim 1, wherein the generating of the second value for each of the plurality of digital channels includes classifying the plurality of users using a convolutional neural network (CNN) model.

6. The method of claim 5, wherein the classifying of the plurality of users by the CNN is based on a set of terms to which each user is bound and a respective activity pattern of the user.

7. The method of claim 6, wherein the machine learning model is retrained periodically based on events that are received from the plurality of digital channels during each period.

8. The method of claim 7, wherein the received events for retraining include events for non-users.

9. The method of claim 1, wherein the machine learning model runs on the cloud server.

10. The method of claim 1, wherein the resources allocated to the plurality of digital channels are displayed on a graphical user interface.

11. A system for automatically allocating resources to digital channels, comprising:
one or more processors with a cloud server running thereon; and
one or more memories that are coupled to the one or more processors and storing program instructions, which, when executed by the one or more processors, cause the cloud server to perform operations comprising:
receiving one or more events associated with each of a plurality of users from at least one of a plurality of digital channels;
constructing, by the cloud server, a sequence of events for each of the plurality of users using a plurality of processing nodes, wherein each of the plurality processing nodes is configured to construct sequences of events for a subset of the plurality of users;
generating, using a machine learning model, a first value for each of the plurality of digital channels for each of the plurality of users based on the respective sequences of events of the plurality of users;
calculating a second value for each of the plurality of digital channels based on the first value of each of the plurality of users and an attribute of each of the plurality of users; and
automatically allocating resources to each of the plurality of digital channels based on the respective second value.

12. The system of claim 11, wherein each of the one or more events is one of: impression, click, engagement, and conversion.

13. The system of claim 11, wherein the machine learning is a Markov chain Monte Carlo (MCMC) model.

14. The system of claim 12, wherein the machine learning model is used in conjunction with a Shapley values algorithm to generate the first value.

15. The system of claim 11, wherein the generating of the second value for each of the plurality of digital channels includes classifying the plurality of users using a convolutional neural network (CNN) model.

16. The system of claim 15, wherein the classifying of the plurality of users by the CNN is based on a set of terms to which each user is bound and a respective activity pattern of the user.

17. The system of claim 16, wherein the machine learning model is retrained periodically based on events that are received from the plurality of digital channels during each period.

18. The system of claim 17, wherein the received events for retraining include events for non-users.

19. The system of claim 11, wherein the machine learning model runs on the cloud server.

20. A non-transitory computer readable storage medium storing program instructions for automatically allocating resources to digital channels, wherein the program instructions, when executed by one or more processors with a cloud server running thereon, cause the cloud server to perform operations comprising:
receiving one or more events associated with each of a plurality of users from at least one of a plurality of digital channels;
constructing, by the cloud server, a sequence of events for each of the plurality of users using a plurality of processing nodes, wherein each of the plurality processing nodes is configured to construct sequences of events for a subset of the plurality of users;
generating, using a machine learning model, a first value for each of the plurality of digital channels for each of the plurality of users based on the respective sequences of events of the plurality of users;
calculating a second value for each of the plurality of digital channels based on the first value of each of the plurality of users and an attribute of each of the plurality of users; and
automatically allocate resources to each of the plurality of digital channels based on the respective second value.
